(19) United States
(12) Patent Application Publication
(10) Pub. No.: US 2001/0038033 A1
(43) Pub. Date: Nov. 8, 2001

(54) Unified communications and commerce systems and methods, and device therefore

(76) Inventor: Ali S. Habib, McLean, VA (US)

Correspondence Address: GREENBERG-TRAURIG, 1750 TYSONS BOULEVARD, 12TH FLOOR, MCLEAN, VA, 22102, US

(21) Appl. No.: 09/815,271

(22) Filed: Mar. 23, 2001

Related U.S. Application Data
(60) Provisional application No. 60/191,484, filed on Mar. 23, 2000.

(51) Int. Cl. G06F 17/00

(52) U.S. Cl. 235/375

(57) ABSTRACT

A client/server system that facilitates communications access. A miniature CD-ROM or other physical media can be used to distribute client software to users. Client distribution media may also include additional software, such as that used to encrypt a document, create a virtual private network, videoconference, and the like. Client distribution media can also be used as a credit card, telephone calling card, debit card, employee identification card, access control card, and for other purposes. A server may act as a central point through which communications services, such as data transmission, telephony, video conferencing, and the like, can be accessed. A server may also store user profile information, such as user preferences, user contact information, user calendar information, and other such information. A server can also allow creation of rule based commerce accounts, which can be accessed through client distribution media, or through methods associated with traditional commerce accounts, such as bank accounts.

### PRIORITY AND COPYRIGHT CLAIMS

This application claims the benefit of U.S. Provisional Patent Application Ser. No. 60/191,484 filed Mar. 23, 2000, the entire disclosure of which is incorporated herein by reference.

### FIELD OF THE INVENTION

The present invention relates generally to the fields of communications and commerce. More specifically, the present invention relates to the provision of voice and data communications to a user, and to banking and electronic commerce.

### BACKGROUND OF THE INVENTION

Computers and the automation resulting therefrom can be found all around us. This computerization has happened only in the relatively recent past, yet as a society we have come to embrace it, rely on it, and even take it for granted. From the computerization and digitization of the telephone system, to electronic banking, electronic credit card transaction processors, and automated teller machines (“ATM's”), to the Internet, the impact of computers can be felt in almost all aspects of our daily lives.

The banking industry was one of the first areas to embrace computerization. For example, computers allowed banks to do away with rooms of human operators verifying consumer purchase credit and replace them with sophisticated computer equipment that could look up credit information almost instantaneously. This ability to verify credit information quickly and accurately has lead to widespread acceptance of credit cards and other forms of “virtual currency.”

For example, as credit cards, such as Visa, American Express, or Master Card, have become more prolific and authorization systems have become more accurate, other companies have offered specialized credit cards. Some of the first specialized credit cards to emerge were “calling cards” from telephone companies such as AT&T of New York, N.Y., and Sprint of Kansas City, Mo. Calling cards allow consumers to place phone calls from a payphone without requiring insertion of any actual currency. As with general credit cards, consumers are periodically billed for calls made using such calling cards.

While post-paid credit cards, such as traditional credit cards and calling cards, have seen widespread acceptance, such cards have also caused problems for card issuers. For example, some merchants may not process credit card information immediately, thus allowing cardholders to spend beyond their means before a card issuer is aware of such spending. As a result, card issuers have become more reluctant to extend credit, and have sought ways of fighting such abuse while still giving consumers the convenience of credit cards.

One solution put forth in the prior art is the “check card.” A check card is essentially a credit card that is tied to a consumer's bank account. With such cards, funds can be immediately withdrawn from a consumer bank account and either transferred to an escrow account or transferred directly into a company's account. If insufficient funds exist in a consumer's account at the time a transaction is processed, the transaction may be declined. Check card users can essentially be seen as prepaying for desired items.

The check card is very similar to another solution in the prior art, the prepaid card. With prepaid cards, virtual “bank accounts” are created for each card, and credit is assigned to each virtual account based on funds provided by a cardholder. As purchases are made, appropriate balance changes are recorded in a virtual account.

Prepaid cards first appeared on the market as specialized, industry-specific and vendor-specific cards. One of the first industries to see widespread use of such cards was the telecommunications industry. Telecommunications card issuers, such as Transit Networks, Inc., of New York, N.Y., and Gestalt Productions of Dallas, Tex., provide a specific number of minutes of discounted telephone time from a pay telephone or home telephone in exchange for an up-front fee.

The popularity of prepaid calling cards proved the economic viability of the prepaid model, and other industries have begun using prepaid cards. For example, many department stores issue prepaid cards in lieu of gift certificates.

Both prepaid and postpaid credit card systems rely on computers and related automation to facilitate communications between a seller and a purchaser's bank account or other account. But banks and other financial institutions are not the only ones to take advantage of such computerization. For example, the telephone and data communications networks that pervade our society are also reliant on computerized systems. From digital cellular phones to the high-speed data network known as the Internet, more and more of our communications needs are addressed by computers.

Just as cellular phones have increased the demand on voice communications, the Internet has caused an explosion in the demand for data communications. This explosion is due to the Internet's ability to allow individuals and corporations to communicate with more convenience and in less time than ever anticipated.

The Internet provides this functionality through an infrastructure created by Internet Service Providers (“ISP's”). Although there are many ISP's in the United States, a majority of consumers access the Internet through dial-up services provided by large, value-added ISP's such as America Online, Inc., of Herndon, Va. or Prodigy Communications Corporation of Austin, Tex.; or through local ISP's affiliated with national ISP networks, such as the iPass network run by iPass, Inc. of Redwood Shores, Calif.

Typical dial-up access provided by both large ISP's and ISP networks requires installation of appropriate dialer software on each computer from which an account is accessed. In addition, large ISP's and ISP networks often require proper user setting configuration before users will be granted access to an ISP's network.

As ISP's and ISP networks grow and become more prevalent, the cost of creating and maintaining a data communications infrastructure continues to decline. This has led some in the prior art to use the existing data communications infrastructure to facilitate voice, video, and other communications as well. For example, iBasis, Inc., of Burlington, Mass., and GRIC Communications, Inc., of Milpitas, Calif., have created networks that utilize the Internet as a voice communications backbone, thereby bypassing much of the traditional telephony (“PSTN”) infrastructure. This communications approach is commonly referred to as Voice Over Internet Protocol, or VoIP.

Others are using the Internet as a central point from which other forms of communications are accessed. For example, Itopia.com of Kortrijk, Belgium, allows users to receive faxes and voicemail through a single telephone number. Further, users can access such faxes and voicemails, as well as E-mails, through an Internet web site, or such faxes and voicemails can be sent as file attachments to an existing E-mail account.

Others, such as iBasis, take this concept one step farther, providing a “follow me” service. In a follow me service, users give their friends, business contacts, or others a single telephone number through which the user can be reached. An Internet interface can be used to configure a list of telephone numbers at which a user can typically be found at various times of the day and various days of the week. When a call is received, the call is automatically rerouted to an appropriate phone number or numbers, as specified by the user. If the user is unavailable, the follow me service can connect the caller with a user's voicemail box and, as with Itopia.com, such voicemails can be accessed via the Internet.

While the Internet is increasingly used for such personal and corporate communications, the Internet is also used for commerce. Many companies are now offering products for sale via World Wide Web storefronts, or “web sites.” Visitors to such web sites can select from various products, select delivery options, and pay for products and delivery using credit cards.

The convenience with which such commerce can be transacted has attracted many people to online shopping. Unfortunately, such transactions have also attracted the attention of criminals. Online, electronic commerce has received a bad reputation lately as credit card numbers and other authorization information have been stolen from various online retailers. Some have sought to reduce or eliminate such problems through various means. For example, American Express is promoting its “Blue” card, which includes a “smart chip” for online purchases. With the Blue card, users attach a device to their computer and, instead of entering a credit card number, users insert their card into the device and enter a Personal Identification Number (“PIN”). The device reads the smart chip to verify that the PIN entered corresponds to the inserted card, and then validates the user's credit.

Other companies are integrating various biometric capabilities into credit cards, web sites, and other systems to reduce the risk of fraud. For example, some computer companies are manufacturing inexpensive hand geometry and fingerprint analysis equipment that can be easily attached to a computer and used for authentication.

However, online systems are not the only systems targeted by criminals; traditional banking and commercial transactions are also fighting fraud by implementing biometrics. For example, some ATM's include iris recognition technology to identify individual users, thus negating the need for an ATM card or a PIN.

### SUMMARY OF THE INVENTION

The present invention is comprised of a combination of software and hardware acting in client software/server arrangement. In addition, the present invention includes a CD-ROM or other physical media that may also be used as a prepaid or postpaid telephone calling card, credit card, debit card, or for other such purposes.

Client software can allow a user to access communications services from a computer or other electronic device (“computer”) equipped with a modem or other hardware or software communications apparatus without significant user interaction. A server portion of the present invention may track user account information, including account balances, payment information, user preferences, and the like.

In a preferred embodiment, client software may be distributed on miniature CD-ROMs, such as those manufactured by Precise Media Inc. of Ontario, Canada. Alternative embodiments contemplated include full-sized CD-ROMs; floppy disks; Click disks, manufactured by Iomega Corporation of Roy, Utah; and other static or rewriteable media. Use of miniature CD-ROMs is preferred, as miniature CD-ROMs can be designed in a variety of shapes and sizes, thus enhancing their marketability.

A user may install client software on a computer, or client software may be run directly from a CD-ROM. Client software may consist of stand-alone computer software, such as a program written in Visual Basic, C++, or other similar language; a series of scripts or other commands requiring an operating environment, such as JAVA Script, Visual Basic Script, or other such language; or client software may consist of a combination of stand-alone software and scripts.

In a preferred embodiment, a user can install and begin using client software by inserting a CD-ROM into a CD-ROM drive or DVD drive, or otherwise causing physical media on which client software has been stored to interact with a computer. Upon such interaction, a computer may automatically run client software. If client software cannot be run, for example because a suitable environment cannot be found or necessary component libraries are not available, client software may automatically begin an installation procedure. An installation procedure can archive current copies of files that the installation procedure may overwrite and install files necessary to allow client software to run.

Client software may also be distributed through an electronic delivery means. Such a delivery means may include, but is not limited to, File Transfer Protocol (“FTP”) or Hypertext Transfer Protocol (“HTTP”) accessible Internet sites.

When client software is first run, client software may archive previously existing communications settings, such as access telephone numbers, user names, Internet Protocol (“IP”) addresses, routing information, and other such information. Client software may then replace previously existing information with information necessary to allow client software to access the Internet. Once properly configured, client software may contact a server and retrieve user-specific information, such as favorite Internet sites, a default home page, advertising, links, and other such information.

Once installed, client software can also facilitate global communications access. Client software may provide voice communications services via the Internet, commonly known as Voice-over-IP (“VoIP”). Client software may also provide access to the Internet and resources available therefrom, such as access to large ISP's, E-mail, the World Wide Web, virtual private networks (“VPN's”), follow me services and unified messaging and the like.

To improve usability, client software may also include a means for switching between network settings associated with the present invention and those stored during an installation process. Switching between settings can allow a user to borrow a computer without disabling a computer owner's Internet access.

In a further aspect of the present invention, when client software is removed from a computer, all settings and data associated with the present invention may be removed. In addition, any settings in place prior to client software installation may be restored, thereby returning a computer to its original state.

### BRIEF DESCRIPTION OF THE DRAWINGS

FIG. 1 is an illustration of the printed surface of a rectangular CD-ROM embodiment of the present invention.

FIG. 2 is an illustration of the underside of a rectangular CD-ROM embodiment of the present invention.

FIG. 3 is an illustration of the printed surface of an oval CD-ROM embodiment of the present invention.

FIG. 4 is an illustration of a plastic sleeve of the present invention that is used to provide global long distance access phone numbers.

FIG. 5 is an illustration of a plastic sleeve of the present invention that is used to provide instructions for the use of the present invention.

FIG. 6 is an illustration of a system for providing Internet access via the present invention.

FIG. 7 is an illustration of a system for providing voice communications access via the present invention.

FIG. 8 is a block diagram of an alternative communications system embodiment of the present invention.

FIG. 9 is a perspective view of a vending machine for distributing physical media associated with the present invention.

FIG. 10 is a flow diagram illustrating logic implemented in a preferred client software embodiment when attempting to establish a communications connection.

FIG. 11 is an illustration of a plastic sleeve portion of the present invention that has been modified to allow access to portions of physical media stored therein.

FIG. 12 is a functional diagram illustrating options available through a commercially oriented embodiment of the present invention.

FIG. 13 is a functional diagram illustrating options available through a personally oriented embodiment of the present invention.

### DETAILED DESCRIPTION OF THE PREFERRED EMBODIMENT

The present invention is comprised of a combination of software and hardware acting in client software/server arrangement. In addition to traditional post-pay telephone and Internet services, a server may provide data, telephony, and other communications services, as well as value-added services, such as allowing users to securely store personal settings and information, and handling credit, billing, or other accounting tasks.

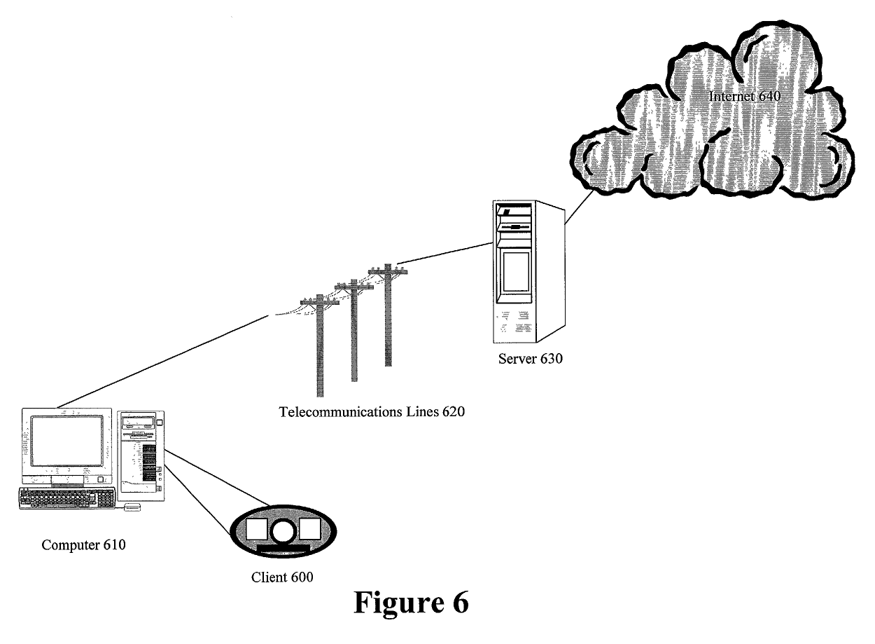

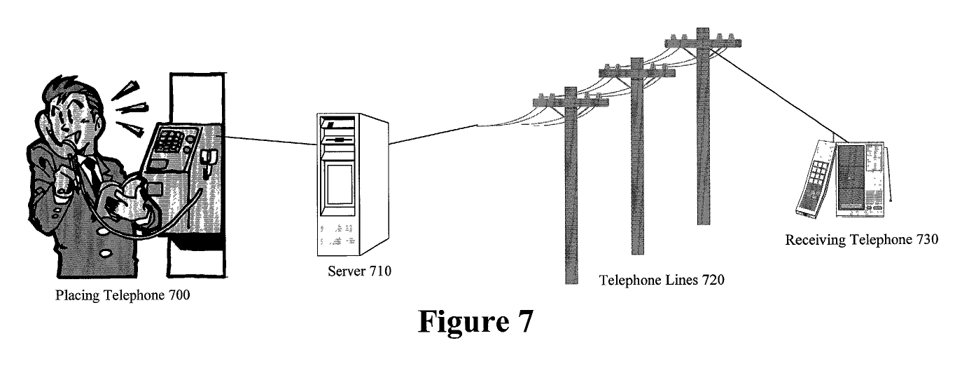

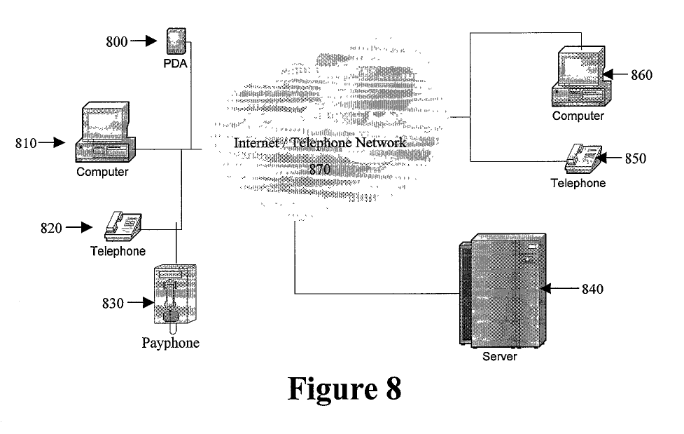

FIGS. 6, 7, and 8 illustrate preferred embodiments of systems providing communications service via the present invention. FIGS. 6 and 7 illustrate a server providing a common point through which communications and other services provided by the present invention may be accessed. FIG. 8 illustrates an alternative, decentralized embodiment of the present invention, in which a server can provide routing and other communications information to client software or other communications equipment, and perform administrative functions.

A server may consist of one or more physical computers that are configured such that each physical computer can provide a specific function or set of functions. Alternatively, each physical computer can provide all functions, and any data processing or communications workload can be distributed among such computers.

Data stored by the present invention may be distributed among database servers (“striped”), may be housed on multiple database servers (“mirrored”), or may be both striped and mirrored. A server can contain various information, including, but not limited to, user names, passwords, a user's favorite web sites, user address books, user demographic information, prepaid time remaining, and balances due. Data may be stored in a server by utilizing commercially available database software, such as Microsoft SQL Server, developed by Microsoft Corporation of Redmond, Wash.; Oracle 8i, developed by Oracle Corporation, of Redwood Shores, Calif.; or other, similar software.

As illustrated by FIG. 6, Server 630 may also consist of communications equipment, such as, but not limited to, analog modems, digital modems, switches, routers, hubs, and multi-channel communications links. Examples of multi-channel communications links can include, but are not limited to, Digital Subscriber Line (“DSL”), T-1 lines, OC-1 lines, and terrestrial or satellite based wireless communications equipment. Such equipment can allow Server 630 to provide Internet, voice, and other communications access.

A user accessing services provided by Server 630 may be required to enter a username, identification number, or other unique identifier (collectively “username”), as well as a password or other authorization information prior to being given access to such services. A user may choose a username and password, or a username may be supplied as part of physical media distribution.

FIG. 7 illustrates a user accessing voice services provided by Server 710. A user placing a telephone call from Placing Telephone 700 may be required to enter a calling card number or other identifier and on authorization code, or a user may cause physical media to interact with a magnetic card reader, barcode scanner, proximity card reader, radio frequency identification (RFID) reader, or other automated identification system, thus reducing the potential for data entry error. A user whose information is automatically entered may be required to enter an authorization code prior to receiving access to services provided by Server 710. Such authorization information may be distributed with physical media, or may be set by a user.

In addition to providing communications access through traditional PSTN networks, the present invention can also facilitate communications via the Internet, private Intranets, and other communications systems. Such functionality can be implemented by client software, which can allow a user to access the Internet or other communications system from any computer or other communications device. Client software may allow such access on a post-paid or prepaid basis.

Installation of client software may cause previously existing communications settings, such as, but not limited to, telephone numbers, user names, Internet Protocol (“IP”) settings, and routing information, to be archived. Once installed, client software may contact a server and retrieve user-specific information, such as favorite Internet sites, default home page, advertising, and the like. In an alternative embodiment, the present invention may retrieve user-specific information from physical distribution media. Such functionality can allow a user to utilize any available computer equipment while still maintaining a consistent user interface and maintaining ready access to a user's data.

Client software may also facilitate global communications access. The present invention may provide voice service via the Internet through VoIP or other such methods. The present invention may also provide access to the Internet and resources available therefrom, such as access to large ISP's, E-mail, the World Wide Web, virtual private networks (“VPN's”), and the like. Further, users can access services provided by a server associated with the present invention, such as, but not limited to, follow me and unified messaging services.

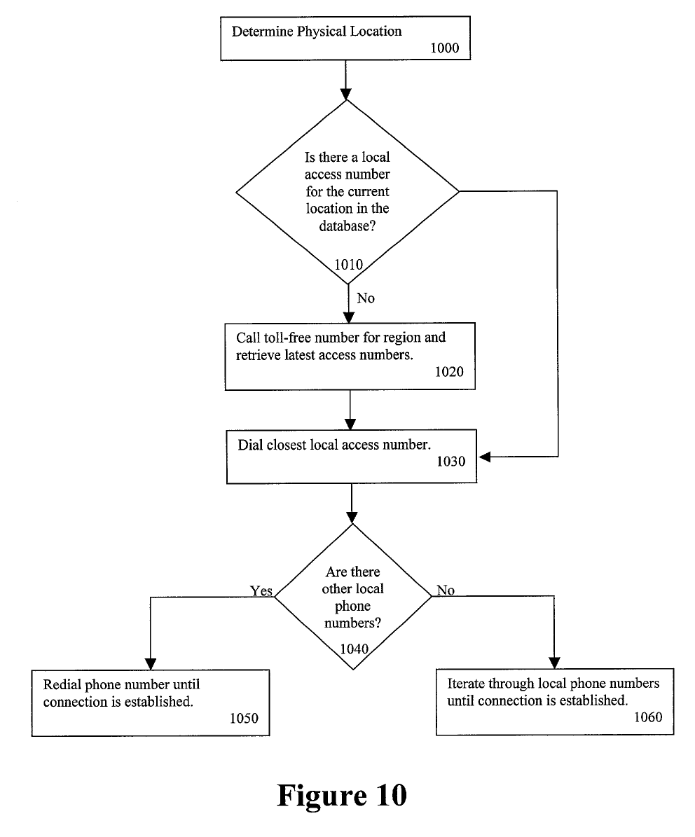

Client software may use a variety of methods for establishing such communications. FIG. 10 illustrates a preferred method by which such communications can be established. As illustrated in Block 1000, client software may determine a present physical location associated with a computer or other device on which such software is run. By way of example, without intending to limit the present invention, a current location can be determined by reading postal codes or telephone area code and prefix settings from an operating system settings file, reading latitude and longitude or other settings from a Global Positioning System (“GPS”) device, or by requesting such information from a user.

When a current location has been established, client software may search a database distributed with client software to select one or more local access information (Block 1010). If said database does not contain any local access information, a toll-free number for the region in which client software is located can be called, and local access information can be determined (Block 1020). When local access information has been determined, client software may iterate through such information, in order of proximity or priority, until a connection is established (Blocks 1040 through 1060). If local access information cannot be determined, client software may present a user with an error message indicating a lack of local access information. In an alternative embodiment, if local access information cannot be determined, users may select from alternatively available communications means for an additional fee.

Once a communications connection is established, a server may track connection times or other usage information for billing purposes. Such tracking may occur as a server directly maintains such communications. In an alternative embodiment, client software may periodically send notifications to a server indicating that a communications connection remains open, and servers may base billing on such notifications. In still another contemplated embodiment, servers may periodically poll client software to determine whether a communications connection is still open, and billing may be based on the result of such polling.

When a communications connection has been closed, client software may reset communications and other settings to a previously archived configuration. For those users running client software from physical media, users can then simply remove such physical media from a computer.

To improve usability, client software may also include a means for switching between settings associated with the present invention and those stored during a client software installation process. Switching between settings can allow a user to borrow a computer without disabling a computer owner's Internet access. In those cases that required installation of client software, client software removal may cause removal of all settings and data associated with such client software and restoration of archived settings, thereby returning a computer to its original state.

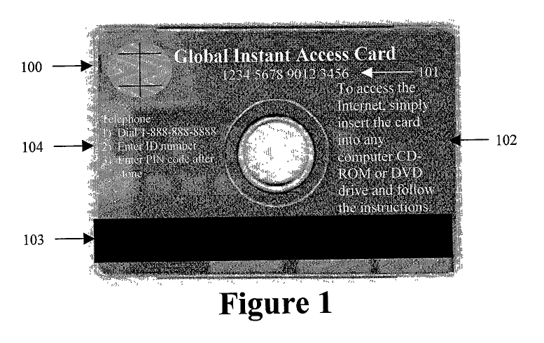

FIG. 1 is an illustration of a printed surface of a rectangular CD-ROM embodiment of the present invention. As illustrated in FIG. 1, a printed surface may contain features such as, but not limited to, a magnetic stripe (Block 103), account or user identification number (Block 101), and a smart chip for reading biometric information or providing proximity or RFID identifiers (Block 100). In addition to their data storage capabilities, miniature CD-ROMs are preferred because such CD-ROMs can be used for other purposes, including, but not limited to, serving as prepaid or postpaid telephone calling cards, debit cards, credit cards, identification cards, or membership cards.

The addition of an account number or other alphanumeric information to a printed surface may allow physical media to function as a standard or prepaid telephone calling card, credit card, debit card, or employee identification card. Adding a magnetic stripe to the printed surface may also allow a calling card or other identification number associated with a card owner to be read by magnetic card readers. Smart chips, RFID tags, and the like can allow the present invention to be used in conjunction with other systems, including, but not limited to, access control, security, and public transit systems.

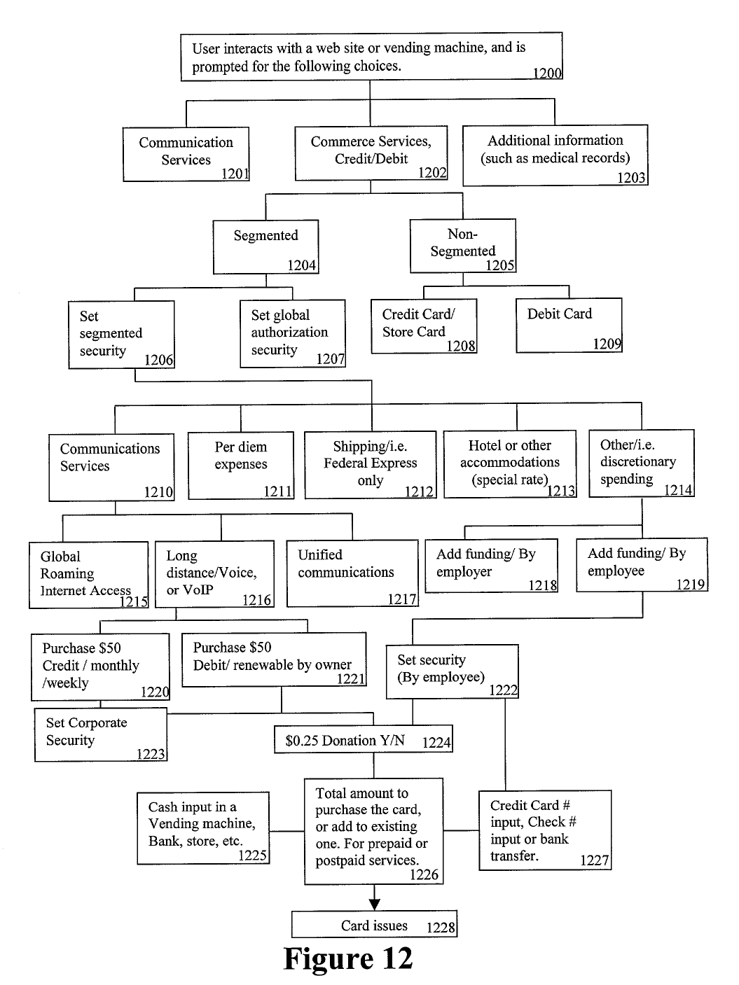

In addition to facilitating communications, the present invention can also provide a unified, electronic-based commerce platform. A presently preferred embodiment, illustrated by FIG. 12, can allow a large corporation to issue physical media as described above to individual employees. A server may allow individual accounts to be created for each issued physical media, groups of physical media, individual users, or groups of users (Block 1200). Highly specific spending and access privileges can then be associated with each account. By way of example, without intending to limit the present invention, a corporation may authorize a specific user to charge up to $500 per month to FedEx or UPS for shipping (Block 1212), and up to $1500 per month to Marriott, Hilton, and Holiday Inn for hotel stays (Block 1213), while not allowing a user to charge any other fees from other vendors to the account (Blocks 1204 and 1205). Payment for such accounts can be made on a prepaid or postpaid basis, and such payment types can be determined on a combination of factors, including, but not limited to, user, vendor, and vendor product category.

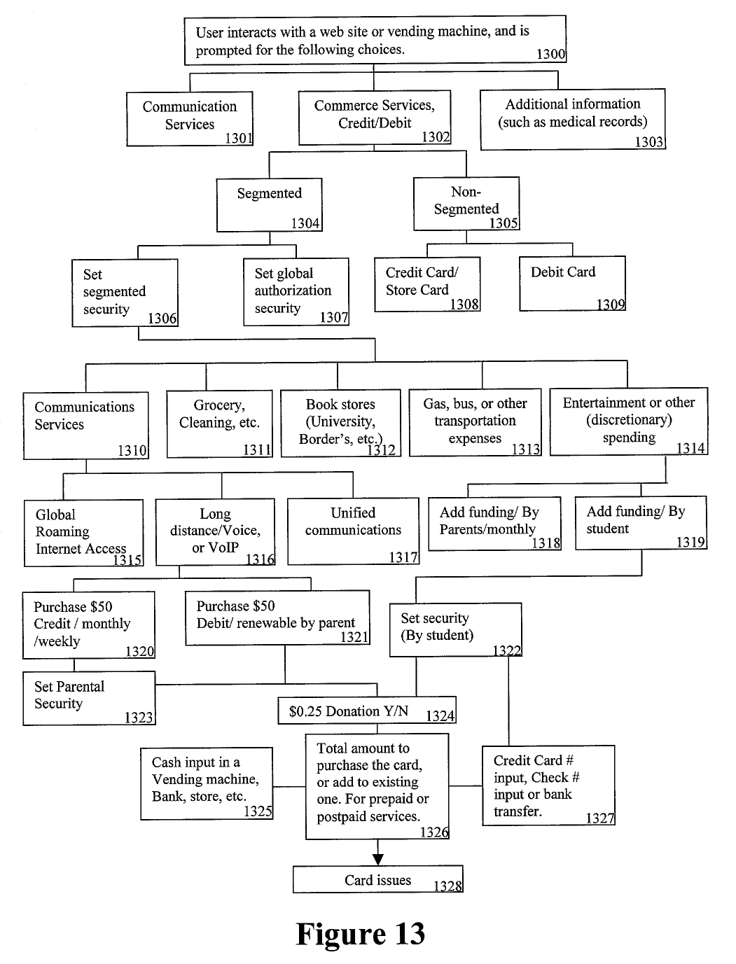

In an alternative embodiment, illustrated by FIG. 13, parents can purchase physical media or create a user account with a preset value, such as a $1,200 credit card (Block 1200). Parents can then specify that a specific portion of a preset value is to be accessible over repeated time increments, and further restrict spending to specific vendors or set spending limits within general product categories (Blocks 1204 and 1205). By way of an example, without intending to limit the present invention, parents can specify that $100 of the card should be accessible each month for the next year. Parents can further specify that, of the $100 accessible each month, up to $50 can be used for purchases from food vendors, up to $25 can be used for purchases from entertainment vendors, and $25 can be used for purchases from clothing vendors. A similar embodiment utilizing postpaid credit, rather than a prepaid account, is also envisioned.

In another embodiment, the present invention can receive Universal Product Code (“UPC”) codes or other products codes as a vendor processes a transaction, thus allowing the present invention to monitor and restrict purchases of specific items.

A server may monitor prepaid and postpaid balances and issue electronic or paper notifications to users advising them of spending habits and account balances. Such notifications can also include categorized charges for accounting and taxation purposes, thus simplifying accounting and taxation procedures.

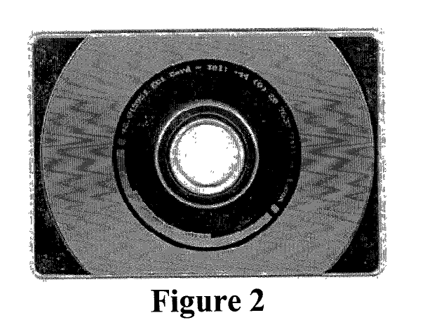

Account information can be stored on physical media for simplified access. Physical media can also serve other purposes. FIG. 2 illustrates the data storage side of a miniature rectangular CD-ROM, which may be used to distribute client software. Distribution of client software via miniature CD-ROMs, such as those manufactured by Precise Media Inc. of Ontario, CA, may be preferred, as miniature CD-ROMs allows significant data storage in a relatively small space, are fairly tolerant of physical and environmental stress, and can be read by most computers without additional hardware.

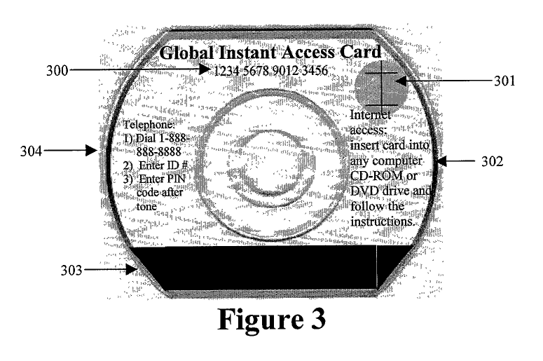

FIG. 3 illustrates the use of an alternatively shaped CD-ROM as the physical media through which the present invention can be distributed. Additional contemplated physical distribution media also include full-sized CD-ROMs; floppy disks; CompactFlash cards; Memory Sticks, such as those manufactured by Sony Corporation of Tokyo, Japan; Click and Zip disks, such as those manufactured by lomega Corporation of Roy, Utah; and other media.

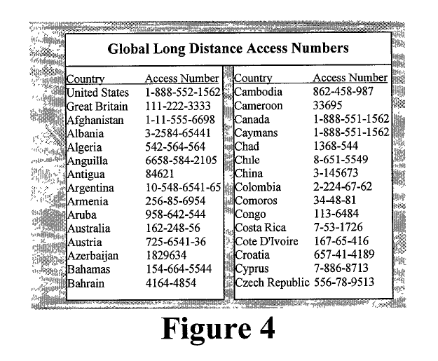

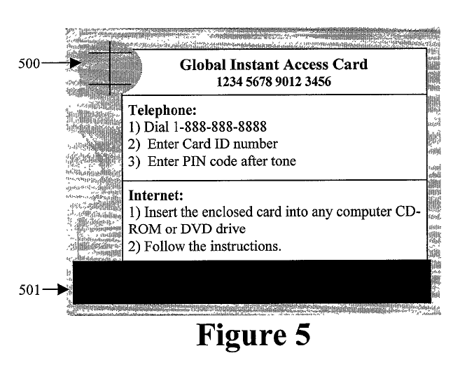

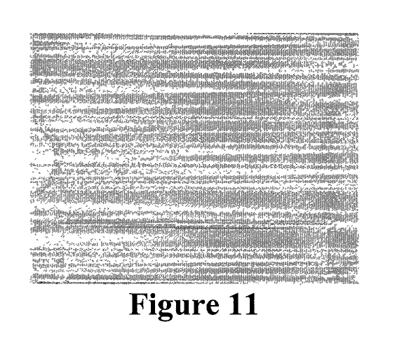

In an alternative embodiment, a sleeve, cover, or other container (collectively “sleeve”) may be distributed with physical media. A sleeve may be used to safely transport physical media, and also to provide a user with easy access to frequently used information, such as global long distance access numbers, usage instructions, and other such information, as illustrated in FIGS. 4 and 5. FIG. 5 also illustrates attachment or implantation of a magnetic strip (Block 501), a smart chip (Block 500), and other such electronically readable components on a sleeve. FIG. 11 illustrates an alternative sleeve embodiment, in which portions of a sleeve have been cut away to expose physical media regions, thereby allowing magnetic strips, smart chips, and the like to be read by devices requiring physical contact with such components.

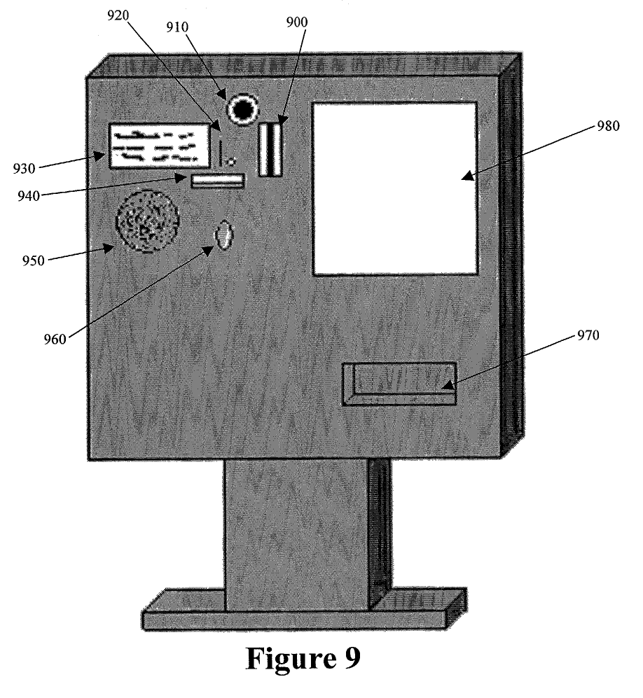

Physical media may be distributed to users by a variety of means, depending on specific utilizations proposed for such physical media. By way of example, without intending to limit the present invention, FIG. 9 illustrates a vending apparatus through which physical distribution media can be distributed. In the embodiment illustrated in FIG. 9, users can read instructions from and interact with a touch-sensitive display (Block 930) to select desired physical distribution media characteristics, organize account information, set access privileges, select optional services, and configure additional options. Physical media can be purchased by entering paper currency into Block 940, coin currency into Block 920, or by presenting a credit card or other payment form to Block 900. Should a user wish to implement biometric or other security, such information can be recorded through a fingerprint or hand geometry measurement device (Block 960), a voice pattern recognition device (Block 950), an iris or facial characteristic recognition device (Block 910), or other such systems. Appropriate information can be recorded on physical media, and physical media can be dispensed through slot 970.

Banking, communications, Internet, and other networks are in the process of merging to enable information to flow faster, thereby enabling users to better access valuable information. This convergence is creating an integrated, cohesive information source that enables users to contemplate and then act upon decisions in an almost instantaneous fashion. By way of example, a user can call a bank and increase a line of credit, then purchase items against this increased credit almost instantaneously.

The present invention is directed at accessing banking, telecommunications, and other information as separate data. However, one can easily anticipate a system by which these disparate systems can be converged into a single data source by utilizing an outside server that is able to combine data from disparate databases, using languages such as XML, and make such data accessible to users in a seamless fashion. An alternative, readily envisioned embodiment of this convergence is the creation of a new device that combines a physical media reader, such as a CD-ROM reader, a biometric reader, such as a fingerprint or hand geometry reader, and a smart card reader. Combining these into a single device can compliment the physical media aspects of the present invention and provide a much smoother and faster user experience that would allow future inventions and applications. Such future inventions and applications can include, but are not limited to, corporate credit and debit cards and accounts; affinity cards; personal financial and banking card and accounts; family financial and banking cards and accounts; travel, including hotel room, ticketing, itineraries, and other information, as well as spending controls based on countries, currencies, and currency exchange rates which can control spending over a travel period; university campus accounts, such as meal plan accounts; club or other membership-based organizations; merchandizing; and department stores/malls.

Through the specification set forth above, it should be apparent to one skilled in the art that the present invention is comprised of a server, which facilitates communications access, client software, which allows a user to contact a server, and physical media. Client software may record customer settings prior to making changes, and may restore those settings when uninstalled or when requested by a user. Physical media may also serve several purposes, including, but not limited to, distributing client software and functioning as a credit card, telephone calling card, identification card, and the like. Such use may be facilitated through equipment such as specialized vending machines, or specialized card readers that can be attached to a user computer.

While the preferred embodiment and various alternative embodiments of the invention have been disclosed and described in detail herein, it may be apparent to those skilled in the art that various changes in form and detail may be made therein without departing from the spirit and scope thereof.

I claim as my invention:

1. A device, comprising:
physical media capable of storing electronically readable data; and
a reference code imprinted on or associated with said physical media which indicates an identity associated with said media.

2. The device of claim 1, in which said reference code includes an account number.

3. The device of claim 2, in which said account number corresponds to a prepaid credit card.

4. The device of claim 2, in which said account number corresponds to a postpaid credit card.

5. The device of claim 1, in which said reference code can be read electronically.

6. The device of claim 5, in which said reference code can be read through a magnetic stripe attached to or embedded in said physical media.

7. The device of claim 5, in which said reference code can be read through a barcode imprinted on the surface of said physical media.

8. The device of claim 5, in which said reference code can be read through a smart chip embedded in or attached to the surface of said physical media.

9. The device of claim 5, in which said reference code can be read through an RFID tag embedded in or attached to the surface of said physical media.

10. The device of claim 1, in which said reference code can be used to control access to physical locations, such as rooms or buildings.

11. The device of claim 1, further comprising a sleeve into which said physical media can be placed, and a reference code imprinted on or associated with said sleeve.

12. The device of claim 11, in which said reference code includes an account number.

13. The device of claim 12, in which said account number corresponds to a prepaid credit card.

14. The device of claim 12, in which said account number corresponds to a postpaid credit card.

15. The device of claim 11, in which said reference code can be read electronically.

16. The device of claim 15, in which said reference code can be read through a magnetic stripe attached to or embedded in said physical media.

17. The device of claim 15, in which said reference code can be read through a barcode imprinted on the surface of said physical media.

18. The device of claim 15, in which said reference code can be read through a smart chip embedded in or attached to the surface of said physical media.

19. The device of claim 15, in which said reference code can be read through an RFID tag embedded in or attached to the surface of said physical media.

20. The device of claim 11, in which said reference code can be used to control access to physical locations, such as rooms or buildings.

21. The device of claim 11, in which one or more portions of said sleeve can be removed to allow portions of said physical media to be accessible through said sleeve.

22. A communications system, comprising:
physical media;
a computer;
a device that allows said computer to access said physical media;
a communications means associated with said computer; and
client software for establishing a personalized communications connection.

23. The communications system of claim 22, in which said client software is stored on said physical media.

24. A communications method, comprising the steps of:
causing physical media to be accessed by a computer;
running client software stored on said physical media;
determining a physical location;
communicating said location to said client software;
selection of one or more appropriate communications access means by said client software based on said location;
determining a user ID, account number, or other identifier associated with a requested communications connection;
validation of said identifier by said client software requesting validation from a server; and
establishment of a communications connection based on said selected access means and validity of said identifier.

25. The communications method of claim 24, in which said physical location is determined by a user entering a zip code, area code, longitude and latitude, or other regional identifier.

26. The communications method of claim 24, in which said physical location is determined from a Global Positioning System device.

27. The communications method of claim 24, in which said communications access means is determined from a database stored on said physical media.

28. The communications method of claim 24, in which said communications access means is determined from a database stored on a server.

29. The communications method of claim 24, in which said communications access means is determined by searching a database stored on said physical media and, in the event an appropriate communications access means cannot be determined, searching a database stored on a server.

30. The communications method of claim 24, in which said communications connection is a data connection.

31. The communications method of claim 24, in which said communications connection is a voice connection.

32. The communications method of claim 31, in which said communications connection is a voice connection established using VoIP.

33. A commerce accounting system, comprising:
an account;
a means for editing account attributes; and
rules defining how funds accessible from said primary account may be dispersed, where such rules can be entered through said account attribute editing means.

34. The accounting system of claim 33, in which said rules can restrict account fund disbursement to specific vendors and vendor groups.

35. The accounting system of claim 33, in which said rules can cause funds associated with said account to be available in specific amounts over one or more time periods.

36. The accounting system of claim 33, in which said rules can indicate individual items and item groups authorized for purchase and prohibited from purchase with funds associated with said account.

37. The accounting system of claim 33, in which said primary account is comprised of a prepaid account.

38. The accounting system of claim 33, in which said primary account is comprised of a postpaid account.
